(19) United States
(12) Patent Application Publication
(10) Pub. No.: US 2002/0198732 A1
(43) Pub. Date: Dec. 26, 2002

(54) Method, computer readable medium and apparatus for encouraging a customer to visit a hair salon

(75) Inventor: Tomoko Yoshida, Sapporo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/090,743

(22) Filed: Mar. 6, 2002

(30) Foreign Application Priority Data
Jun. 25, 2001 (JP) 2001-190920

(51) Int. Cl. G06F 17/60

(52) U.S. Cl. 705/1

(57) ABSTRACT

A method of encouraging a customer to visit a hair salon is provided. The method includes the steps of deriving an expected date of visit of the customer and producing direct mail containing suggestions of hairstyles that can be applied to the customer when the expected date of visit of the customer is a predetermined period ahead.

### BACKGROUND OF THE INVENTION

1. Field of the Invention

The present invention relates to assisting a customer in determining her/his hairstyle, and more particularly to a method, a computer readable medium and an apparatus for encouraging a customer to visit a hair salon by producing direct mail in which a plurality of latest hairstyles that are appropriate for the customer's present hair conditions are suggested.

2. Description of the Related Art

In order to decide a hairstyle, a customer must personally gather vast amounts of latest hairstyle information from magazines or through the Internet. Therefore, gathering information about hairstyles is time-consuming in the conventional manner. Further, the customer needs to visit the hair salon to discuss hairstyles with the hairdresser while the hairstyle decision has not yet been made and therefore considerable time and effort are needed before a final decision can be made.

With such a conventional manner, it is necessary for a hairdresser of the hair salon to have a direct conversation with the customer since recommendations and suggestions of hairstyles are made based on personal preference, appearance and personality of each customer. Therefore, such recommendations and suggestions are only possible through a telephone conversation made upon reservation. Also, direct mail (DM) sent from the hair salon often serves simply as a greeting card and it is a burden on the hair salon to send messages for each customer.

Thus, before achieving a desired hairstyle, the customer needs to make a number of communications with the hairdresser. Also, there are often cases where both the customer and the hairdresser are not satisfied with the final outcome.

In the conventional manner, the hairdresser simply has to follow the customer's order and therefore it is difficult to offer a service with a satisfactory result to the customer. As for the customer, it is difficult to determine whether or not the hairstyle she/he desires truly suits her/him and to compare a number of hairstyles in a virtual manner. Therefore, a long time may be spent at the hair salon to discuss the hairstyle with the hairdresser in charge. There are often cases where many steps are needed to gather and select information required to decide the customer's desired hairstyle. Further, in order to decide her/his desired hairstyle, basic information about her/his own hair, such as length, type, diameter and balance must be gathered. However, it is cumbersome to obtain the basic information and thus it is a burden on the hair salon to collect and analyze the basic information about the customer.

### SUMMARY OF THE INVENTION

Accordingly, it is a general object of the present invention to provide a method, computer readable medium and an apparatus that can obviate the above problems.

It is another and more specific object of the present invention to provide a method, computer readable medium and an apparatus that can assist the customer in deciding her/his hairstyle and can encourage the customer to visit a hair salon by producing direct mail in which a plurality of latest hairstyles that are appropriate for the customer's present hair conditions are suggested.

In order to achieve the above objects according to the present invention, a method of encouraging a customer to visit a hair salon is provided that includes the steps of:

a) deriving an expected date of visit of the customer; and

b) producing direct mail containing suggestions of hairstyles which can be applied to the customer when the expected date of visit of the customer is a predetermined period ahead.

A computer readable medium and an apparatus for performing such a method are also provided according to the present invention.

According to the present invention, the customer can personally select a hairstyle from available hairstyles without collecting and analyzing vast information herself/himself. Also, since the customer acquires information required for deciding the hairstyle through direct mail before visiting the hair salon, time required for deciding the hairstyle while visiting the hair salon can be reduced. The hair salon can manage information of each customer and send direct mail appropriate for each customer. Thus, direct mail serves not only as a greeting card but also as material for positively offering information to the customer. Accordingly, direct mail has an effect of encouraging the customer to use services offered by the hair salon and increasing the re-visit rate of the customer to the hair salon. Further, members of the hair salon can search for hairstyles appropriate for the customer's present hair conditions via the Internet.

### BRIEF DESCRIPTION OF THE DRAWINGS

FIG. 1 is a system configuration block diagram of an embodiment of the present invention.

FIG. 2 is a hardware configuration diagram of an embodiment of the present invention.

FIG. 3 is a diagram showing a screen image of direct mail (DM) document produced in accordance with the present invention.

FIG. 4 is a diagram showing an example of a customer information management table (address, name, telephone number, etc.)

FIG. 5 is a diagram showing an example of a customer information management table (length, diameter and type of hair of customer, etc.)

FIG. 6 is a diagram showing an example of a hairstyle table.

FIG. 7 is a diagram showing an example of a code table (latest hairstyles).

FIG. 8 is a flowchart showing an operation of registering customer information according to the present invention.

FIG. 9 is a flowchart showing an operation of sending direct mail according to the present invention.

FIG. 10 is a flowchart showing an operation of deriving expected next date of visit of the customer according to the present invention.

FIG. 11 is a flowchart showing an operation of producing direct mail according to the present invention.

### DETAILED DESCRIPTION OF THE PREFERRED EMBODIMENTS

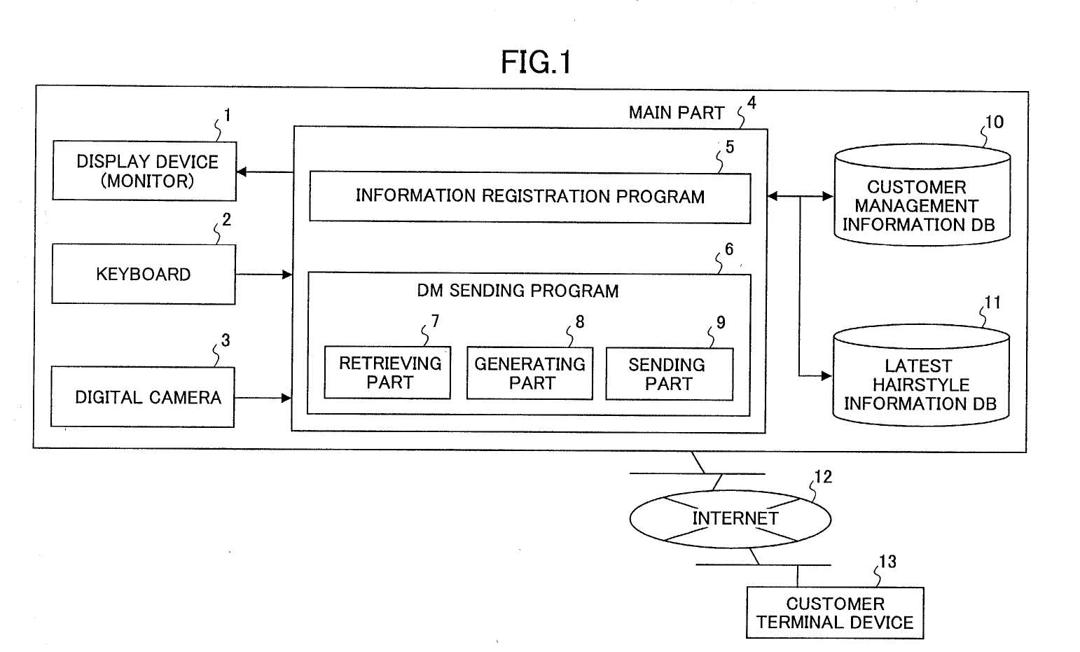

In the following, principles and embodiments of the present invention will be described with reference to the accompanying drawings. Referring to FIG. 1, a customer-encouraging assisting apparatus 14 includes a display device (monitor) 1, a keyboard 2, a digital camera 3, a main part 4 that controls an information-registering program 5 and a DM (direct mail)-sending program 6, a customer management information DB (database) 10 and a latest hairstyle information DB 11.

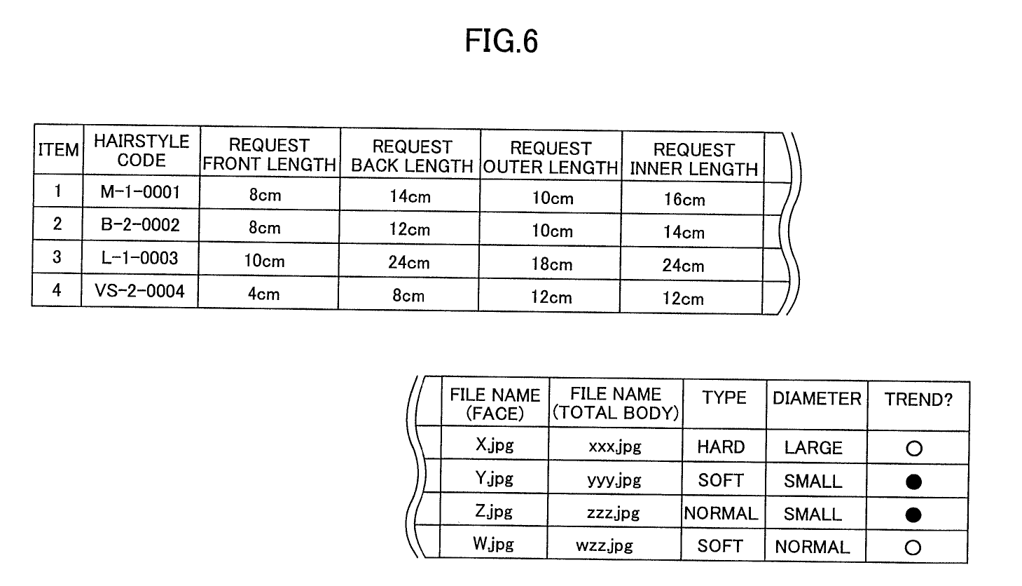

The information-registering program 5 is a program for registering basic information of a customer upon a visit to the hair salon and includes different registering steps depending on whether it is a first visit or not. This aspect will be described later in detail with reference to FIG. 6.

The DM sending program 6 includes an retrieving part 7 for extracting a particular recommended hairstyle based on the basic customer information and an expected next date of visit, a generating part 8 for producing direct mail after creating a database by combining photographic images of the customer and the latest hairstyle data, and a sending part 9 for sending the produced DM.

The main part 4 includes the information-registering program 5 and the DM sending program 6.

The customer management DB 10 and the latest hairstyle information DB 11 are both connected to the main part 4. A customer terminal device 13 can send customer numbers to the customer-encouraging assisting apparatus 14 via the Internet 12 and can retrieve and select desired hairstyles for the customer from the latest hairstyle information DB 11 and display the hairstyles on the display device 1.

The latest hairstyle DB 11 obtains latest hairstyles through the Internet or from magazines and registers them as a database.

The display device 1 displays customer information which has been obtained by the retrieving and extracting operations from the customer management information DB 10 and the latest hairstyle information DB 11.

The generating part 8 derives expected next date of visit for each customer from constant value information such as date and time of the latest visit, average visit interval, direct mail sending/producing interval and visit interval. Then, the data are categorized into three patterns such as first visit customers, non-regular customers and regular customers. Then, information of a particular customer is retrieved and direct mail document for the customer is produced by combining the retrieved information and the photographic images of the customer.

The sending part 9 sends the DM produced at the generating part 8 to a particular customer in accordance with the visit interval information used as the predetermined value in the above-described step of deriving the expected next visit.

The Internet 10 serves as a network for transmitting screen configuration information generated by the customer-encouraging assisting apparatus 14 to the customer terminal device 13 and for transmitting information to be researched from the customer terminal device to the customer-encouraging assisting apparatus 14.

Also, a method of encouraging the customers to visit the hair salon according to the present invention may be realized on a server device, which is a computer as has been described above. Then, the schedule or reservation status of the hairdresser in charge managed by the server device can be referred to from a client device such as the customer terminal device or a shop terminal device. Also, a communication with the hairdresser in charge can be made for selecting the most desired hairstyle. Further, the latest information may be made available on the Web Site of the hair salon for a wider selection of hairstyles.

In the present embodiment, an E-mail transmission is taken as an example of a means for encouraging the customer, but other information transmitting means such as postal cards, letters and facsimile transmissions are also possible.

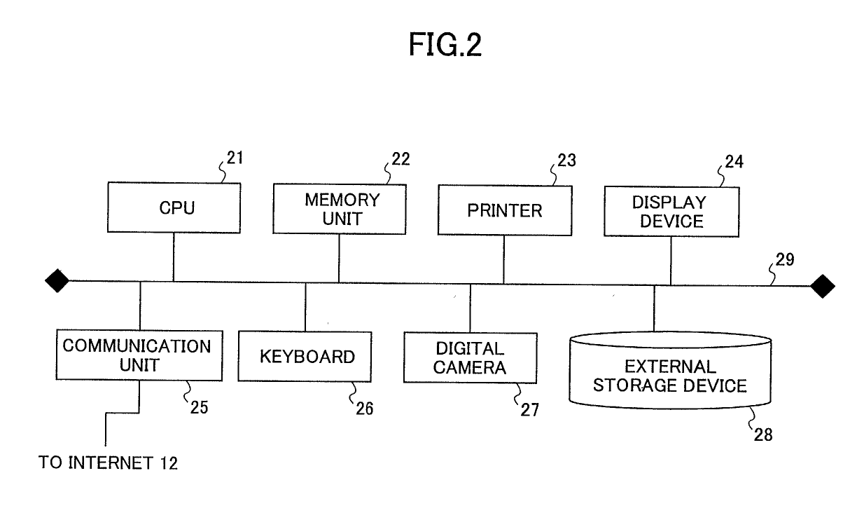

FIG. 2 is a hardware configuration diagram of the customer-encouraging assisting apparatus 14 of an embodiment of the present invention.

Referring to FIG. 2, the hardware configuration of the customer-encouraging assisting apparatus 14 of the present invention includes a CPU (Central Processing Unit) 21, a memory unit 22, a printer 23, a display device 24, a communication unit 25, a keyboard 26, a digital camera 27 and an external storage device 28. These units 21 through 28 are connected to a bus 29.

The CPU 21 controls the customer-encouraging assisting apparatus 14 in accordance with a program stored in the memory unit 22 and performs direct mail generating process and a generating process related to screen configuration in the customer-encouraging assisting-apparatus 14.

The memory unit 22 stores programs executed on the CPU 21 and data required for processes executed on the CPU 21. Also, a part of a region of the memory unit 22 is temporarily allocated as a work area used for processes executed on the CPU 21 and in which the information registering program 5 and the DM sending program 6 are stored.

The printer 13 prints the result of the processes performed and any other specified information. In the customer-encouraging assisting apparatus 14 of the present invention, the direct mail may also be sent using an actual postal service or may be printed on paper to preserve it.

The display device 24 displays various information that is necessary for operating the customer-encouraging assisting apparatus 14 under control of the CPU 21. With the customer-encouraging assisting apparatus 14 of the present invention, a search result obtained by the retrieving part 7 under a certain condition can be displayed on the display device 24.

The communication unit 25 transmits screen configuration information for displaying the customer information on the customer terminal device 13. The customer information is information generated based on input information about the customer. Also, the communication unit 25 connected to the Internet 12 serves to communicate E-mail messages and data on Web pages.

The keyboard 26 and the digital camera 27 serve as input devices that input customer-specific information into the customer-encouraging assisting apparatus 14 such that the customer-specific information is used for generating direct mail. The keyboard 26 and the digital camera 27 are also used for inputting various information elements necessary for performing a generating process for outputting screen configuration information on the display device 24. Signals transmitted from the input control devices such as the keyboard 26 and digital camera 27 are transmitted to the CPU 21 via the bus 29.

The external storage device 28 is, for example, embodied on a hard disk and registers the customer management information DB 10, the latest hairstyle information DB 11 and the programs shown in FIG. 1 and customer information input through the keyboard 26 and the digital camera 27. The external storage device 28 stores the information while issuing the customer number.

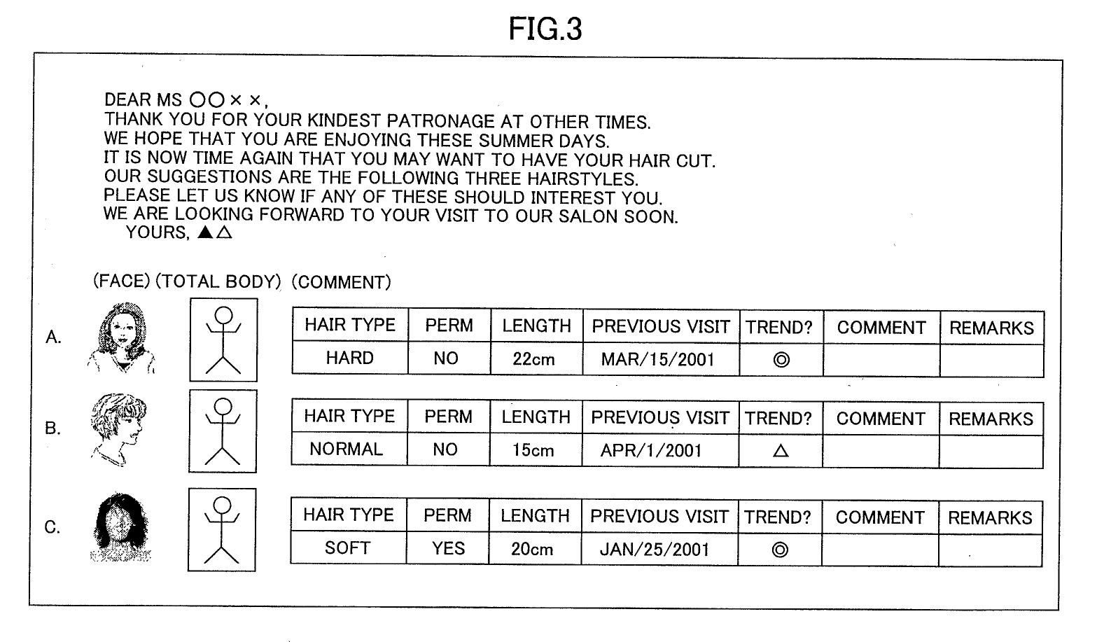

FIG. 3 is a screen image diagram of direct mail (DM) document sent to a specific customer.

Referring to FIG. 3, each record (customer information linked to a customer number) stored in the customer management information DB 10 and each record (latest hairstyle information) stored in the latest hairstyle information DB 11 are managed in a linked manner. Then, a customer linked to customer information extracted under a particular condition is selected. A plurality of hairstyles for the selected customer, which are determined to be well-suited for the customer based on the latest hairstyles and the hair growth rate, are provided in direct mail to be sent to the selected customer. Accordingly, the present invention enables assisting the customer in deciding the hairstyle herself/himself and thus the customer uses the present invention by referring to the hairstyles suggested by the hair salon to decide her/his own hairstyle. If required, the hairdresser in charge may add comments in the “REMARKS” column that may help the customer to decide her/his own hairstyle.

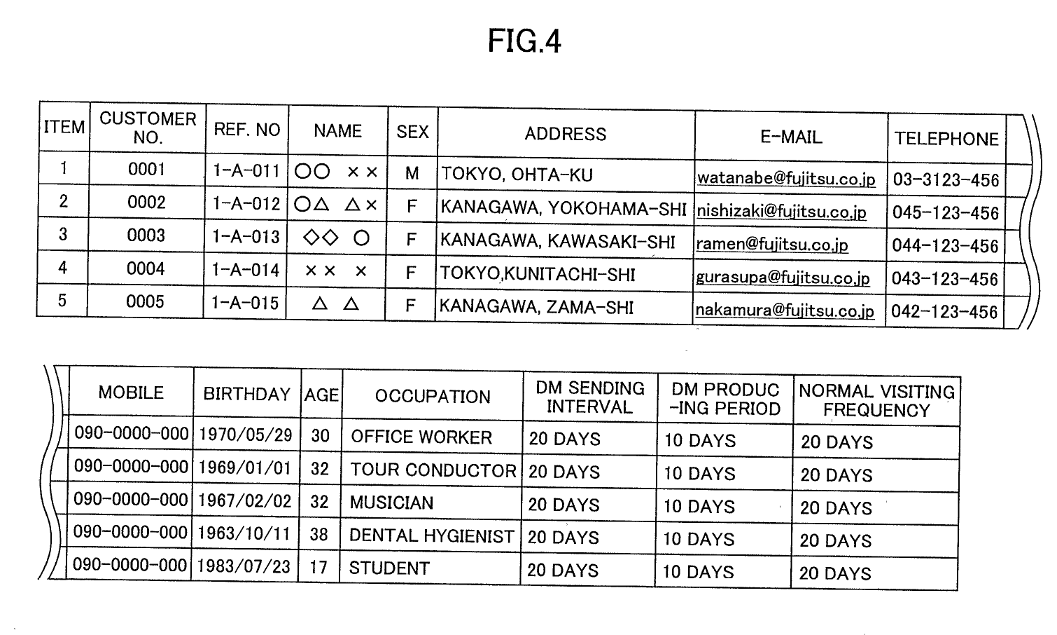

FIG. 4 is a diagram showing an example of a customer information management table.

As shown in FIG. 4, each record (customer management information) stored in the customer management information DB 10 includes fields related to customer number, management number, name, sex, postal address, E-mail address, telephone number, mobile telephone number, birthday, age, occupation, DM sending interval, DM producing interval and normal visit interval.

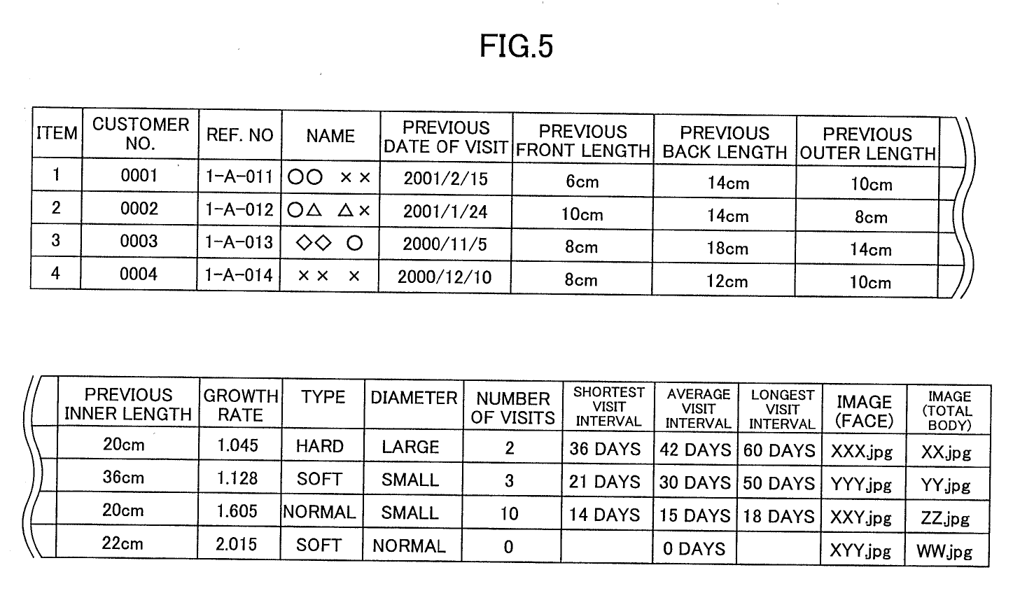

FIG. 5 is a diagram showing an example of another customer information management table.

As shown in FIG. 5, each record (customer management information) stored in the customer management information DB 10 includes fields related to customer number, management number, name, previous date of visit, previous length of hair (front, back, outer and inner), growth rate, type, diameter, number of visits, shortest visit interval, average visit interval, longest visit interval, an image of the face and an image of the total body.

FIG. 6 is a diagram showing an example of a hairstyle table.

As shown in FIG. 6, each record (hairstyle information) stored in the latest hairstyle information DB 11 includes fields related to style code, required length (front, back, outer and inner), image file name of the face, image file name of the total body, type of hair, diameter of hair, whether it is a trend or not.

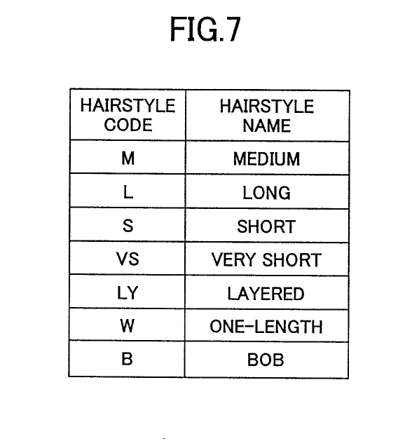

FIG. 7 is a diagram showing an example of a hairstyle code.

As shown in FIG. 7, each record (hairstyle information) stored in the latest hairstyle information DB 11 includes fields related to Hairstyle Code and Hairstyle Name.

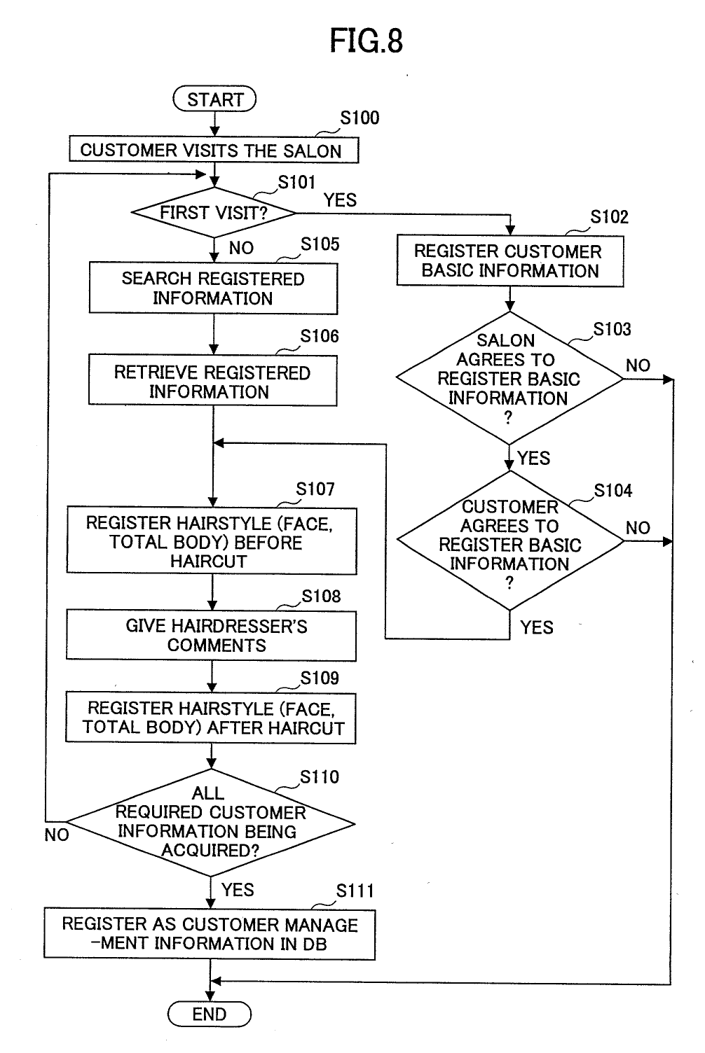

FIG. 8 is a flowchart showing an operation of registering customer information according to the present invention. When the flow starts, the following process is performed.

Step S100: A customer visits the hair salon. At this point, it is known only that there is a “visit” and attributes of the customer are not known.

Step S101: It is determined whether it is the first visit to the hair salon or not. If it is the first visit, the process proceeds to step S102 where the basic information of the customer is registered. If the customer has at least once previously visited the hair salon, the process proceeds to step S105 where the customer information stored in the customer management information DB 10 is retrieved.

Step 102: The basic customer information is registered in the customer management information DB 10. The data to be registered are specific information elements such as name, sex, address, E-mail address, telephone number, mobile telephone number, birthday, age and occupation.

Step S103: The hairdresser in charge determines whether or not to register the basic information of the customer into the customer management information DB 10. If the basic information is to be registered, the process proceeds to step S104. If not, in other words, if the customer clearly indicates that she/he is not coming to the hair salon again or if the hair salon refuses to allow the customer to come again for some reason, the process terminates.

Step S104: The customer determines whether or not to register her/his own information in the customer management information DB 10. If the information is to be registered, the process proceeds to step S107. If not, in other words, if the customer clearly indicates that she/he is not coming to the hair salon again or if the hair salon refuses to allow the customer to come again for some reason, the process terminates.

Step S105: When the result of step S101 is negative, the process proceeds to step S105 where the customer information currently registered in the customer management information DB is retrieved. The retrieval may be performed through a terminal device installed at the hair salon when the customer visits the hair salon or through a terminal device of the customer by the customer transmitting her/his customer number.

Step S106: Information registered in the customer management information DB 10 is extracted. The information elements of the records extracted in this step are customer number, management number, name, sex, address, E-mail address, telephone number, mobile telephone number, birthday, age, occupation, previous visited date, length of hair (front, back, Outer and Inner) for previous visited date, hair growth rate, type of hair, diameter of hair, number of visits, shortest visit interval, average visit interval, longest visit interval and images of the face and total body of the previous visit.

Step S107: After extracting all information about the customer, images of the face (front view) and the total body of the customer are acquired using a digital camera and input to the customer-encouraging assisting-apparatus 14 as an information of the hairstyle before haircut.

Step S108: Any comments from the hairdresser in charge are added to the customer management information. The comments are information required for offering suggestions of hairstyles. The comments may be conversation between the hairdresser in charge and the customer, cloths, hobby, and interest of the customer, preference of hairstyles desired by the customer, sense of fashion of the customer.

Step S109: Images of the face (front view) and the total body of the customer are acquired via a digital camera 3 and input to the customer-encouraging assisting-apparatus 14 as information about the hairstyle before the haircut.

Step S 110: It is determined whether all data required for the customer information have been obtained or not. The required data are customer number, management number, name, sex, address, E-mail address, telephone number, mobile telephone number, birthday, age, occupation, previous visited date, length of hair (front, back, outer and inner) for previous visited date, hair growth rate, type of hair, diameter of hair, number of visits, shortest visit interval, average visit interval, longest visit interval and images of the face and total body of the previous visit.

If it is determined that all required data have been obtained, the process proceeds to step S111. When the result of step S110 is negative, the process returns to step S101 where it is determined whether or not it is the first visit for the customer.

Step 111: If it is determined that all required data have been obtained, the information is registered in the customer management information DB 10 as the customer management information. The above steps are performed in the process of registering the customer information.

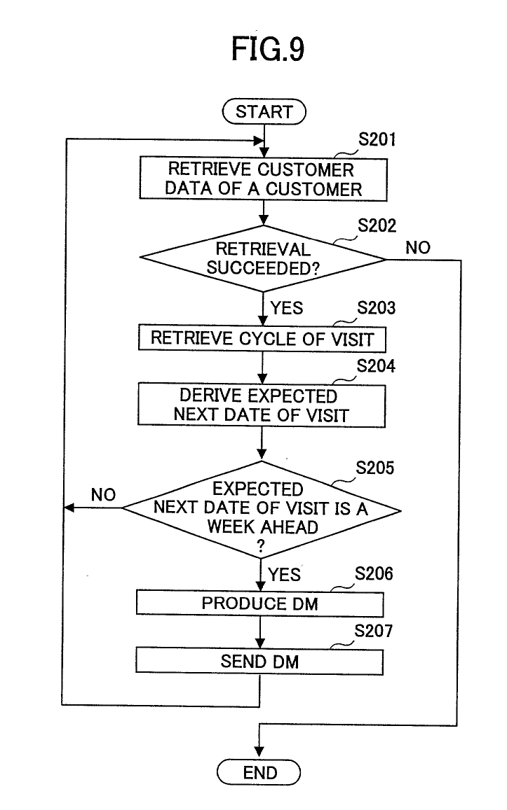

Referring to FIG. 9, a process of sending direct mail according to the present invention will be described. When the flow starts, the following process is performed.

Step S201: Customer information of one of the customers is extracted from the customer management information DB 10.

Step S202: It is determined whether extraction of the customer information has succeeded or not. If the extraction has succeeded, the process proceeds to step S203 and the days of cycle of visit of the customer is extracted. If not, the process terminates.

Step S203: The days of cycle of visit of the customer is extracted. The days of cycle is derived by calculating “average visit interval” based on “number of visits”, “shortest visit interval” and “longest visit interval” in a field in the customer management table of FIG. 5. The days of cycle for each customer is obtained from the “average visit interval” and is preregistered.

Step S204: Expected next date of visit is derived. Details of this step will be described later.

Step S205: It is determined whether or not the derived expected next date of visit is one week ahead or not. If it is one week ahead, the process proceeds to step S206. If it is not, the process returns to step S201 where the customer information of another one of the customers is extracted.

Step S206: Direct mail (DM) document is produced. Details of this step will be described later.

Step S207: The direct mail (DM) is sent to the customer. Details of this step will be described later. The above steps are performed in the process of sending the direct mail.

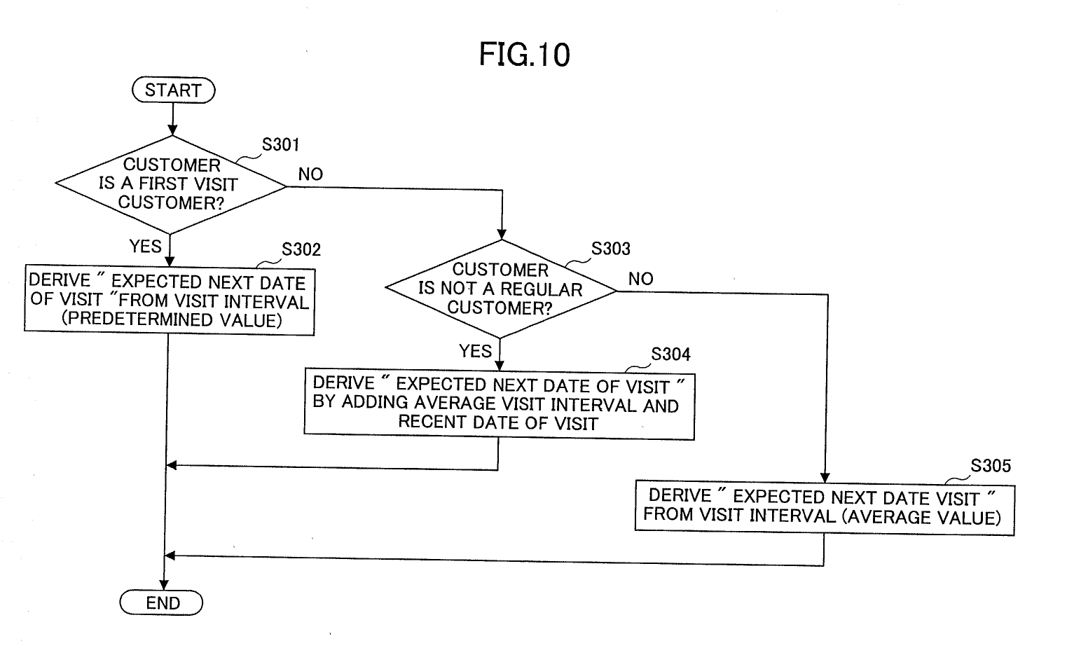

Referring to FIG. 10, a process of calculating expected next date of visit according to the present invention will be described. When the flow starts, the following process is performed.

Step S301: It is determined whether or not a customer is a first visit customer. The determination is made by referring to the “number of visits” field in the customer management table (FIG. 5) in the customer management information DB 10. If it is a first visit customer, the process proceeds to step S302 where expected next visit is derived. If not, the process proceeds to step S303 where determination is made as to whether or not the customer is a non-regular customer. Herein, the “non-regular customer” refers to a customer who has visited the hair salon once or twice in the past.

Step S302: Expected next date of visit is set to any default value (in this case, a visit interval of a normal customer and is a constant value. E.g., one month).

Step S303: It is determined whether or not the customer is a non-regular customer. If the customer is a non-regular customer, the process proceeds to step S304 where expected next date of visit is derived. If not, the process proceeds to step S305 where expected next date of visit is derived.

Step S304: In order to derive expected next date of visit of the “non-regular customer”, any default value (in this case, a visit interval of a normal customer and is a constant value. E.g., one month) is obtained from the average visit interval (variable value).

Step S305: If the customer is not a “non-regular customer”, the customer can be defined as a “regular customer” who has visited the hair salon more than three times. In this case, expected next date of visit is calculated as a sum of the average visit interval and the previous date of visit. The above steps are performed in the process of calculating expected next date of visit of the customer.

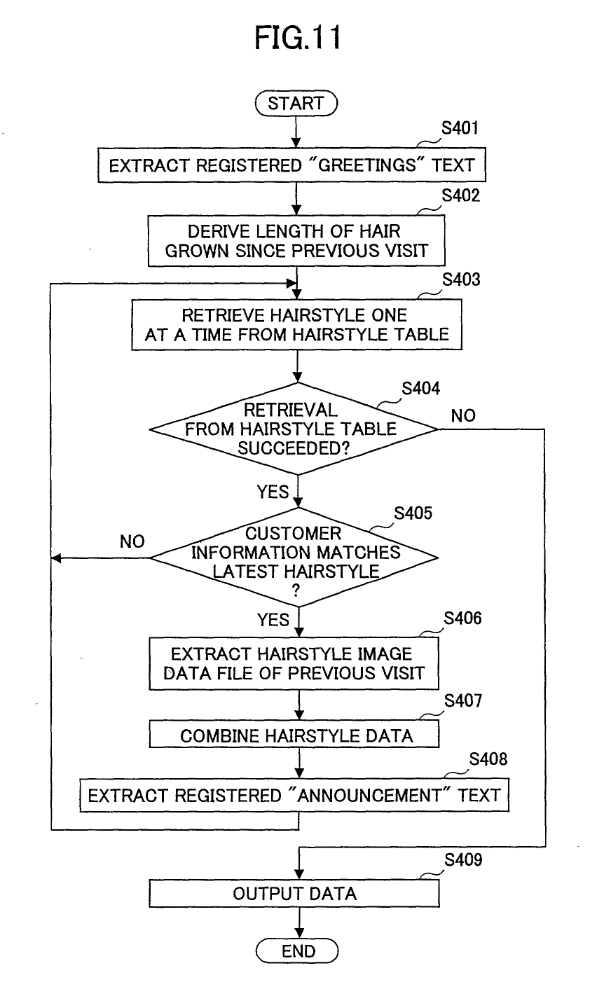

Referring to FIG. 11, a process of producing direct mail according to the present invention will be described. When the flow starts, the following process is performed.

Step S401: A “greetings text”, a plurality of which have been registered as templates, is output. Herein, the “greetings text” refers to standard texts appropriate for the season of the year such as “Thank you for your kindest patronage at other times. We hope that you are enjoying these summer days.”

Step S402: The length of hair growth of the customer is calculated. In detail, the data of the length of hair before haircut such as length of hair (front, back, outer and inner) for the previous visit in the customer management table of FIG. 5 and the product of the number of days between the previous haircut and the expected next date of visit and a numerical value assumed by the hair salon, such as 1 to 3 cm per month, are added to derive an expected length of hair for the next visit.

Step S403: Latest hairstyle data are retrieved hairstyle by hairstyle from the hairstyle table of FIG. 6. For each latest hairstyle, required conditions such as the length, type and diameter of hair, which are predefined in the table, are referred to.

Step S404: It is determined whether or not latest hairstyle data have been retrieved from the hairstyle table of FIG. 6. If the latest hairstyle data have been retrieved, the process proceeds to step S405 in which it is determined whether or not the customer information and the latest hairstyles match. If not, the information is printed by the printer 23 and the process terminates.

Step S405: It is determined whether or not the customer information matches with the latest hairstyles. In detail, it is determined whether or not there is a match between the expected length, diameter and type of hair for the next visit, which have been derived in step S402, and the conditions such as the length of hair required for each hairstyle in the hairstyle table of FIG. 6. If the customer information matches with the latest hairstyles, the process proceeds to step S406 where the hairstyle image data file of the previous visit is extracted from the customer management information DB 10. If not, the process returns to step S403 where the latest hairstyles are retrieved from the hairstyle table.

Step S406: The image data files (face and total body) acquired upon the previous visit of the customer are extracted from the customer management table of FIG. 5, which is stored in the customer management DB 10.

Step S407: The hairstyles extracted from the latest hairstyle information DB 11 and the hairstyle acquired upon the previous visit are combined.

Step S408: The preregistered “announcement text” is extracted. Herein, the “announcement text” refers to text that encourages the customer to consider about her/his hairstyle, such as “Our suggestions are the following three hairstyles. Please let us know if any of these should interest you. We are looking forward to your visit to our salon soon.” After step S408, the process proceeds to step S403 where the hairstyle data are retrieved from the hairstyle table.

Step S409: If the process fails to retrieve the latest hairstyle data from the hairstyle table, the data are output and the process terminates.

Further, the present invention is not limited to these embodiments, and variations and modifications may be made without departing from the scope of the present invention.

The present application is based on Japanese priority application No. 2001-190920 filed on Jun. 25, 2001, the entire contents of which are hereby incorporated by reference.

What is claimed is:

1. A method of encouraging a customer to visit a hair salon, said method comprising the steps of:
a) deriving an expected date of visit of the customer; and
b) producing direct mail containing suggestions of hairstyles that can be applied to the customer when said expected date of visit of the customer is a predetermined period ahead.

2. The method as claimed in claim 1,
wherein in said step a), an expected next date of visit of the customer is derived based on pervious date and time of visit information and average visit interval information of the customer.

3. The method as claimed in claim 1, further comprising the steps of:
c) retrieving hairstyles that match with preferences of the customer from a hairstyle information database in which hairstyle information is stored; and
d) extracting management information such that required conditions are extracted by a customer information registering means and a customer number register issuing means from a customer management information database in which customer information is registered in the form of a database.

4. A computer readable medium storing program code for causing a computer to encourage a customer to visit a hair salon, comprising:
first program code means for deriving an expected date of visit of the customer; and
second program code means for producing direct mail containing suggestions of hairstyles that can be applied to the customer when said expected date of visit of the customer is a predetermined period ahead.

5. An apparatus for encouraging a customer to visit a hair salon, said apparatus comprising:
input means via which information related to the customer is input into said apparatus;
a first database in which information related to the customer is stored;
a second database in which information related to latest hairstyles is stored; and
a processing part including an registration program for registering information into said first and second databases and direct mail sending program that derives an expected date of visit of the customer using data obtained from said first database and, when said expected date of visit of the customer is a predetermined period ahead, produces direct mail containing suggestions of hairstyles that can be applied to the customer using data obtained from said first and second databases.

6. The apparatus as claimed in claim 5, wherein said first database includes fields related to data such as customer number, management number, name, sex, postal address, E-mail address, telephone number, mobile telephone number, birthday, age, occupation, direct mail sending interval, direct mail producing interval, normal visit interval, previous date of visit, previous length of hair (front, back, outer and inner), growth rate, type, diameter, number of visits, shortest visit interval, average visit interval, longest visit interval, an image of the face and an image of the total body.

7. The apparatus as claimed in claim 5, wherein said second database includes fields related to data such as style code, required length (front, back, outer and inner), image file name of the face, image file name of the total body, type of hair, diameter of hair, and whether it is a trend or not.
